(19) United States
(12) Patent Application Publication
(10) Pub. No.: US 2013/0337424 A1
(43) Pub. Date: Dec. 19, 2013

(54) SPLIT IMAGE SHOE INDICATOR SYSTEM AND METHOD OF USE

(71) Applicant: Tammy Jo Selix, Unionville, IA (US)

(72) Inventor: Tammy Jo Selix, Unionville, IA (US)

(21) Appl. No.: 13/915,039

(22) Filed: Jun. 11, 2013

Related U.S. Application Data
(60) Provisional application No. 61/659,585, filed on Jun. 14, 2012.

(51) Int. Cl. G09B 19/00

(52) U.S. Cl. CPC G09B 19/0076
USPC 434/267

(57) ABSTRACT

A system and method for indicating which shoe goes upon which foot. The system includes a pair of shoes and a single image that is easily discernible by children and those with diminished capacities. The image is split into a left portion and a right portion. The image is one that children who may lack certain cognitive abilities are able to easily form the two pieces of the image into a single image, like a puzzle. The left portion of the image is placed on the left shoe and the right portion of the image is placed on the right shoe. This can be accomplished by printing the split image directly on the soles of the shoes or shoe sole inserts themselves. This provides the advantage of indicating which shoe is the left shoe and which shoe is the right shoe.

### CROSS REFERENCE TO RELATED APPLICATION

This application claims the benefit of U.S. Provisional Application No. 61/659,585 filed Jun. 14, 2012.

### BACKGROUND OF INVENTION

This invention relates to shoes. More specifically, and without limitation, this invention relates to a device and method of use to help determine which shoe goes on which foot.

Many young children, as well as adults with learning disabilities, struggle mightily to determine which shoe goes upon which foot. Many parents, grandparents, teachers and caretakers have repeatedly had to correct shoes being placed on the wrong foot. This can be an extremely frustrating and time consuming process for both the child as well as the caretaker.

The problem with conventional shoes is that the left shoe and the right shoe look very similar to one another. That is, the differences between the left shoe and the right shoe are not easily discernible to children and others with diminished cognitive capacities.

To help aid children in determining which shoe goes on which foot, some shoes are labeled with the words “LEFT” or “RIGHT” or the letters “L” or “R”. While this may assist many children, many other children do not possess the cognitive ability to discern what these terms mean, or to remember which foot is their left and which foot is their right.

Therefore a need exists in the art to rectify these problems.

Thus it is a primary object of the split-image shoe indicator system is to provide an indicator which identifies which shoe goes upon which foot that is easily understood by children and those with diminished cognitive capacities.

Another object of the split-image shoe indicator system is to prevent shoes from being placed on the wrong feet by children and those with diminished cognitive capacities.

Yet another object of the split-image shoe indicator system is to reduce the frustration experienced by parents, teachers and caretakers related with shoes being placed on the wrong feet by children and those with diminished cognitive capacities.

Another object of the split-image shoe indicator system is to aid learning which shoe goes upon which foot by children and those with diminished cognitive capacities.

Yet another object of the split-image shoe indicator system is to make learning which foot goes in which shoe a fun and enjoyable process for children and those with diminished cognitive capacities.

Another object of the split-image shoe indicator system is to provide a system that is easy to use.

Yet another object of the split-image shoe indicator system is to provide a system that is inexpensive.

Another object of the split-image shoe indicator system is to provide a system that can be retroactively used with any existing footwear.

These and other objects, features, or advantages of the present invention will become apparent from the specification and claims.

### BRIEF SUMMARY OF THE INVENTION:

A system and method for indicating which shoe goes upon which foot. The system includes a pair of shoes and a single image that is easily discernible by children and those with diminished capacities. The image is split into a left portion and a right portion. The image is one that children who may lack certain cognitive abilities are able to easily form the two pieces of the image into a single image, like a puzzle. The left portion of the image is placed on the left shoe and the right portion of the image is placed on the right shoe. This can be accomplished by printing the split image directly on the soles of the shoes themselves. Alternatively, this can be accomplished by printing the split image on shoe sole inserts and inserting them into the shoes themselves. This provides the advantage of indicating which shoe is the left shoe and which shoe is the right shoe thereby reducing or eliminating the possibility of the shoes being placed on the wrong feet.

### BRIEF DESCRIPTION OF THE DRAWINGS:

FIG. 1 is a perspective view of a pair of shoe-sole inserts having a split image printed thereon, with a left portion of the image on the left shoe sole, and the right portion of the image on the right sole;

FIG. 2 is a perspective view of a pair of flip-flop type shoes having a split image printed directly thereon, with a left portion of the image on the left shoe sole, and the right portion of the image on the right sole;

FIG. 3 is a top elevation view of a plurality of shoe-sole inserts having a split image printed thereon, with a left portion of the image on the left shoe sole, and the right portion of the image on the right sole, the shoe sole inserts being combined into a single piece for convenient sale and use.

### DETAILED DESCRIPTION OF THE PREFERRED EMBODIMENT

Conventionally, a pair of shoes 10 consist of a left shoe 12 and a right shoe 14 which are in structure generally mirror images of one another. While conventional shoes are often ordained with countless forms of ornamentation, this ornamentation merely improves the aesthetic appearance of the shoes 10 and does nothing to assist young children or adults with diminished cognitive capacities to help discern which shoe goes on which foot. In fact, this ornamentation often confuses the issue as it tends to obscure the subtle differences between the left shoe 12 and the right shoe 14. When presented with these shoes 10 children and others with diminished cognitive capacities often get confused as to which shoe 10 is the left 12 and which is the right 14.

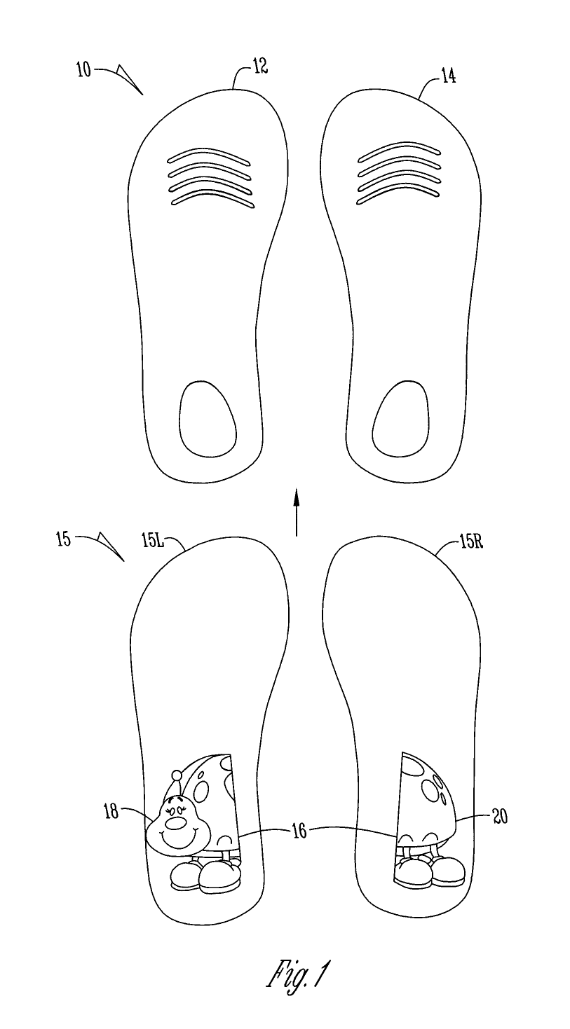

Shoe Sole Inserts: With reference to FIG. 1, a pair of shoe sole inserts 15 is presented. Specifically, these shoe sole inserts 15 consists of a left shoe sole insert 15L and a right shoe sole insert 15R which are in structure generally mirror images of one another. However, the top surface of the shoes sole inserts 15 have an image 16 printed thereon which is not a mirror image on the left shoe sole insert 15L and the right shoe sole insert 15R. Instead, the single image 16 is split into a left portion 18 and a right portion 20. The left portion 18 of this image 16 is then placed or printed on the left shoe sole insert 15L. The right portion 20 of this image is then placed or printed on the right shoe sole insert 15R.

While any image 16 can be used, as an example an artistic ladybug is presented which is approximately cut in half. The left shoe sole insert 15L has the head and first half of the lady bug thereon. The right shoe sole insert 15R has the back half of the lady bug printed thereon. Many children or adults who lack the cognitive ability to discern which shoe is the left 12 and which shoe is the right 14 possess the cognitive ability to discern that the image of the ladybug is split in half and they further possess the ability to form the full image of the ladybug by placing the shoes together. This is not unlike putting the pieces of a puzzle together. When the child puts the two pieces of the puzzle together, this reveals to them which foot goes into which shoe. Approaching the determination of which shoe is the left 12 and the right 14 as a puzzle or a game makes the process fun and enjoyable for many children. To aid in this process it is helpful to select the image that has an easily understood top and bottom (like a head and feet). It is also helpful to select an image that has an easily discernible left side and right side or front and back (like the front half of a dog and back half of a dog). It is especially helpful to use an image of an animal that has a head-end and a tail-end (such as a dog having a head and a tail, or a fish having a head and a tail). This top/bottom and left/right orientation helps the child or adult to identify which way to orient the shoes 10. To further aid in this orientation, the split between the left portion 18 and the right portion 20 is tagged, jagged or puzzle-like, wherein when assembled the two pieces, left portion 18 and right portion 20 fit together to form a seamless image. In this way the split image locks or intermeshes together with two puzzle pieces, which provides the child with further indication that the image is put together properly.

The shoe sole inserts 15 can be any form of a shoe sole insert. As one example, the split image 18, 20 can be placed or printed directly on a pair of Dr. Scholl's insoles, or insoles manufactured by any other maker, and then sold separately from shoes themselves to the consumer. This provides the advantage of improving the ergonomics of the shoe while also indicating the foot each shoe goes upon. Alternatively, the split image 18, 20 is placed on a sheet of foam or rubber or other non-compressible material which is then cut into proper shape to fit the shoes 10. Alternatively, the split image 18, 20 is printed on a single flat layer of paper, plastic, or any other non-compressible material which is then cut into proper shape to fit the shoe. This provides the advantage of indicating which shoe goes on which foot while not adding the cost associated with a full insole or a compressible material.

By using shoe sole inserts, instead of directly printing the split image 18, 20 into the shoe itself this provides the advantage of the shoe sole inserts 15 being removable while simultaneously allowing for a durable and high quality image to be printed directly onto the shoe sole inserts 15. That is, when a split image 18, 20 is permanently printed directly into shoes 10, the split image cannot be removed and used with other shoes 10. The same can be said for stickers with the split image 18, 20 printed thereon. Generally stickers are somewhat permanent fixtures. Once a sticker is stuck to a first pair of shoes 10, it cannot be removed. If the sticker is removed from the first pair of shoes, it will never stick to a second pair of shoes with the same strength, vigor and durability as it stuck to the first pair of shoes. This is especially true in the harsh environment of being within a shoe. As such, stickers are undesirable in this application as they are generally limited to one pair of shoes. As such printing the split image directly onto shoe sole inserts 15 provides the advantage that the shoe sole inserts 15 can be removably and replaceably used with a plurality of shoes 10 without harming the split image 18, 20 or reducing the longevity of its life.

Another improvement to using shoe sole inserts 15 over mere stickers with a split image thereon, is that the shoe sole inserts can be easily sized and shaped fit the entire sole-area shoe 10. This provides the advantage that the user will not even realize that the shoe sole inserts 15 are within the shoe 10 because the user's feet cannot feel any seam or line between the split image 18, 20 and the sole of the shoe 10. In contrast, by using a mere sticker, there is a seam or line around the entire sticker that can be felt by the user. Furthermore, by using a sticker the edge of the sticker is prone to delamination which can also be felt as the sticker folds over itself at the edges. This also reduces the alethic appeal of the sticker and reduces its useful life.

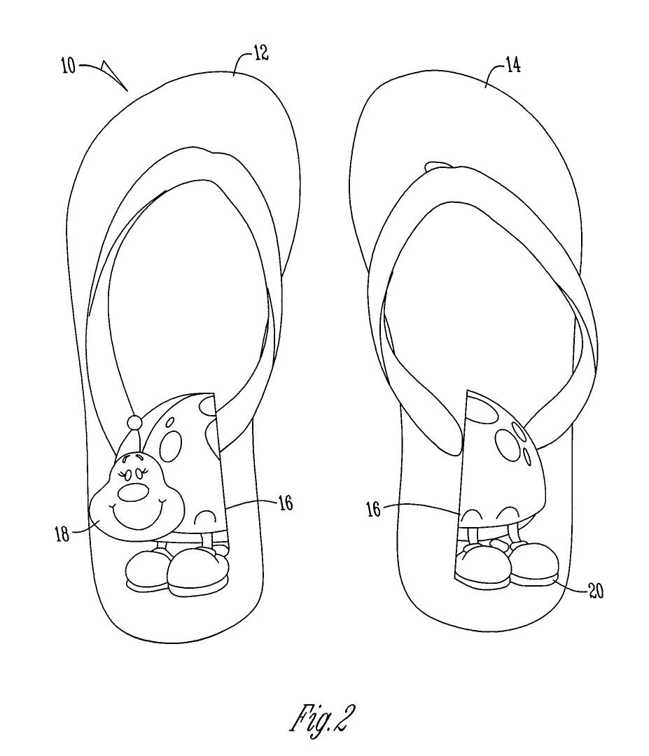

Printed Directly Onto Shoes: In an alternative arrangement, the split image is printed directly onto shoes 10 themselves. Some shoes 10 do not lend themselves well to the use of either stickers with the split image 18, 20 thereon, or the use of shoe sole inserts 15. With reference to FIG. 2, an example of these shoes include what are conventionally known as flip-flops. Flip-flops are a minimalist form of shoe and essentially consist of a rubber or foam sole with at thong-portion which holds the sole to the user's foot. As the user walks, the sole portion of the shoe has a great deal of motion. This motion would greatly wear and cause a sticker to quickly delaminate if place on the sole of the flip-flop as such stickers having the split image 18, 20 thereon cannot effectively be used with flip-flop shoes. In addition, because flip-flops lack structure, or a shoe-body around the sole, shoe sole inserts 15 cannot be effectively used with flip-flops.

Many other forms of shoes also suffer from these or other deficiencies and as such, shoe sole inserts 15 or stickers cannot be used effectively with these shoes. In these applications, it is beneficial to directly print the split image 18, 20 onto the shoe itself. The split image 18, 20 is printed directly on the top surface of the sole of the shoe eliminating the use of or need for a sticker or shoe sole insert 15.

Alternatively, while the split image 18, 20 has been discussed herein as being used on or adjacent to the sole of a shoe 10, the split image 18, 20 can be used on any portion of the shoe itself. As one example, the split image 18, 20 is printed on the back of the shoe 10 adjacent the heal. Alternatively, the split image 18, 20 is printed on top of the toe-area of the shoe 10. Alternatively, the split image is printed on the inside or outside of the tongue area of the shoe 10. Alternatively, the split .image 18, 20 is printed directly onto any other portion of the shoe 10.

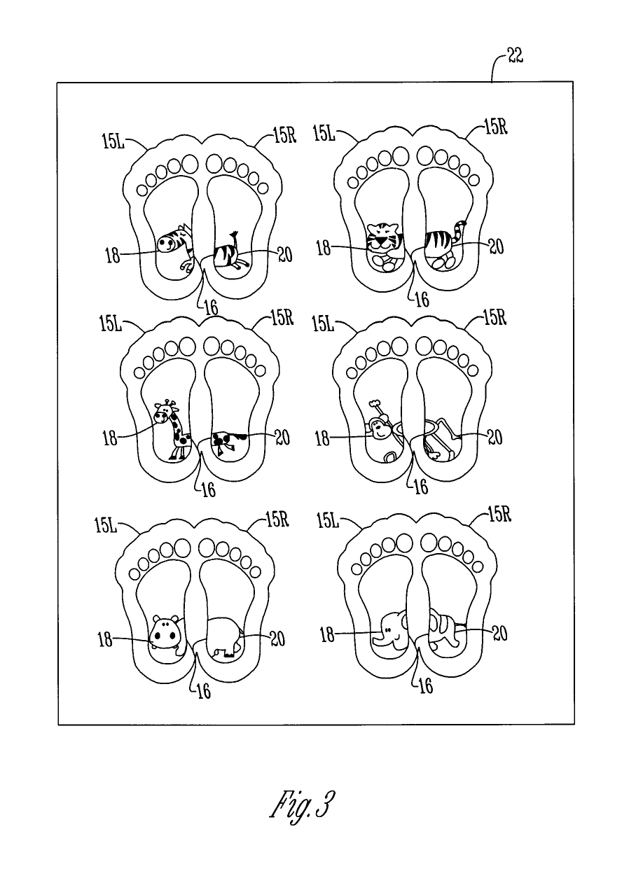

Sheet Of Inserts: In an alternative arrangement, with reference to FIG. 3, shoe sole inserts 15 having a split image 18, 20 printed thereon are sold as a single sheet 22 of material. This sheet 22 of material can be of any form, either compressible such as a sheet of foam, rubber or the like. Alternatively, this sheet 22 of material can be formed of a non-compressible yet durable material such as a composite or plastic or the like.

As is shown, these shoe sole inserts 15 are sold connected together with a general outline around the left shoe sole insert 15L and the right shoe sole insert 15R. Selling the shoe sole inserts 15 in this form provides the advantage that the buyer can then custom cut the left shoe sole insert 15L and the right shoe sole insert 15R from the sheet of material, as such, in this form the shoe sole inserts are essentially one-size-fits-all. Selling the shoe sole inserts 15 in this form also reduces the cost to produce the product because a cutting step is avoided, and the need to stock various sized products is also avoided.

As is shown in this figure, each shoe sole insert 15 is shown with an artistic shaded foot area over which the split image 18, 20 is placed. These split images 18, 20 include an artistic rendition of a zebra, a tiger, a giraffe, a monkey, a hippo and an elephant. Any other character or creature is hereby contemplated for use in this manner.

This sheet 22 can be sold with any number of shoe sole inserts 15 therein. That is, the sheet 22 can be sold having only one pair of shoe sole inserts 15. Or, as is shown, the sheet 22 can be sold with six sets of shoe sole inserts 15 thereon. By selling sheet 22 with a plurality of sets of shoe sole inserts 15 allows one product to be more universal and more likely to please a broader audience of consumers.

Cross Branding: This system also lends itself well to cross branding with famous trademarked or copyrighted characters, designs, logos, terms or any other design or feature. As an example of this, half of “Dora The Explorer” is placed on each shoe, or half of “Mickey Mouse” is placed on each shoe. This cross-branding or cross-licensing provides many commercial advantages to the system.

From the above discussion it will be appreciated that presented is a system and method that offers many advantages over the prior art. Namely the system and method of use provides an indicator which identifies which shoe goes upon which foot that is easily understood by children; prevents shoes from being placed on the wrong feet. The system and method also reduces the frustration related with shoes being placed on the wrong feet; provides an aid to learning which shoe goes upon which foot; and makes learning which foot goes in which shoe a fun and enjoyable process.

It will be appreciated by those skilled in the art that other various modifications could be made to the device without parting from the spirit and scope of this invention. All such modifications and changes fall within the scope of the claims and are intended to be covered thereby.

What is claimed:

1. A shoe alignment system comprising:
a left shoe sole insert;
a right shoe sole insert;
a left portion of an image printed directly on the left shoe sole insert;
a right portion of an image printed directly on the right shoe sole insert;
wherein when the left shoe sole insert and the right shoe sole insert are properly aligned with one another the left portion of an image and the right portion of an image combine together to form a full image thereby indicating proper alignment.

2. The system of claim 1 wherein the left shoe sole insert is inserted into a left shoe, and the right shoe sole insert is inserted into a right shoe.

3. The system of claim 1 wherein the full image is of a creature having a head end and a tail end.

4. The system of claim 3 wherein the head end is printed on one of the left shoe sole insert or right shoe sole insert, whereas the tail end is printed on the other of the left shoe sole insert or right shoe sole insert.

5. A shoe alignment system comprising:
a left shoe;
a right shoe;
a left portion of an image printed directly on the left shoe;
a right portion of an image printed directly on the right shoe;
wherein when the left shoe and the right shoe are properly aligned with one another the left portion of an image and the right portion of an image combine together to form a full image thereby indicating proper alignment.

6. The system of claim 5 wherein the full image is of a creature having a head end and a tail end.

7. The system of claim 6 wherein the head end is printed on one of the left shoe or right shoe, whereas the tail end is printed on the other of the left shoe or right shoe.

8. A shoe alignment system comprising:
a sheet of material;
a first set of shoe sole inserts printed on the sheet of material;
the first set of shoe sole inserts includes a left shoe sole insert and a right shoe sole insert;
a left portion of an image printed directly on the left shoe sole insert;
a right portion of an image printed directly on the right shoe sole insert;
wherein when the first set of shoe sole inserts are properly aligned with one another the left portion of an image and the right portion of the image combine together to form a full image thereby indicating proper alignment.

9. The shoe alignment system of claim 8 wherein a second set of shoe sole inserts printed on the sheet of material.

10. The shoe alignment system of claim 8 wherein the first set of shoe sole inserts are cut out of the sheet of material from the sheet of material.
